(19) United States
(12) Patent Application Publication
(10) Pub. No.: US 2019/0066640 A1
(43) Pub. Date: Feb. 28, 2019

(54) MUSICAL INSTRUMENT CASE

(71) Applicant: K.H.S. Musical Instrument Co., Ltd., New Taipei City (TW)

(72) Inventor: Chien Ru Yeh, Taipei City (TW)

(21) Appl. No.: 15/701,263

(22) Filed: Sep. 11, 2017

(30) Foreign Application Priority Data
Aug. 30, 2017 (TW) 106212866

(51) Int. Cl. G10G 7/00

(52) U.S. Cl. CPC G10G 7/005

(57) ABSTRACT

A musical instrument case includes a first housing and a second housing that are hollow to collectively provide a space for accommodating a musical instrument; and a ridge disposed on the first housing to define a predetermined area. The second housing has at least one recess with a contour corresponding to a periphery of the ridge. Accordingly, the ridge on the first housing embeds in the recess of the second housing when two musical instrument cases are stacked.

### CROSS-REFERENCE TO RELATED APPLICATIONS

This application claims priority of Taiwan Application No. 106212866, filed on Aug. 30, 2017, the entire contents of which are hereby incorporated by reference.

### BACKGROUND OF THE INVENTION

### 1. Field of the Invention

The present invention generally relates to a musical instrument case, and more particularly to a musical instrument case capable of being stacked and protecting stuck decals.

### 2. Description of Related Art

Musical instruments, which are generally fragile, need be carried in, and protected by, musical instrument cases for storing and transporting the musical instruments. Further, some stacking mechanisms have been designed to save storage or transport space.

Conventional musical instrument cases mostly have monotonous color (for example, color black). However, stickers are sometimes placed on the surface of the musical instrument cases for visual appeal, ownership identification or branding. The surface area of the musical instrument case is generally limited. The surface area adaptable for placing stickers becomes more limited when a large part of the surface area has been taken by the stacking mechanism. Moreover, it is observed that the stickers placed on the conventional musical instrument cases suffer scratching, warping and detaching.

A need has thus arisen to propose a musical instrument case with a novel mechanism that both provides a stacking function and protects stickers from damage.

### SUMMARY OF THE INVENTION

In view of the foregoing, it is an object of the embodiment of the present invention to provide a musical instrument case that not only provides a stacking mechanism, but also furnishes a protective space for sticking decals, thereby facilitating visual appeal, ownership identification, branding, added value, customization, and, more importantly, protects the decals from scratching, warping and detaching.

According to one embodiment, a musical instrument case includes a first housing, a second housing and a ridge. The first housing and the second housing are hollow to collectively provide a space for accommodating a musical instrument. The ridge is disposed on the first housing to define a predetermined area. The second housing has at least one recess with a contour corresponding to a periphery of the ridge. Accordingly, the ridge of the first housing embeds in the recess of the second housing when two musical instrument cases are stacked.

According to another embodiment, a musical instrument case includes a first housing, a second housing, a ridge and a decal. The first housing and the second housing are hollow to collectively provide a space for accommodating a musical instrument. The ridge is disposed on the first housing to define a predetermined area. The decal is stuck unto the predetermined area, and is protected by the ridge.

### BRIEF DESCRIPTION OF THE DRAWINGS

FIG. 1 shows a front perspective view illustrated of a musical instrument case according to one embodiment of the present invention;

FIG. 2A shows a front elevational view of the musical instrument case of FIG. 1;

FIG. 2B shows a rear elevational view of the musical instrument case of FIG. 1;

FIG. 2C shows a bottom plan view of the musical instrument case of FIG. 1;

FIG. 2D shows a top plan view of the musical instrument case of FIG. 1;

FIG. 3A and FIG. 3B show two exemplary decals for sticking unto the predetermined areas of FIG. 2A respectively;

FIG. 4 show a front view of a second musical instrument case being stacked on top of a first musical instrument case;

FIG. 5 shows one exemplary decal for sticking unto the recess of FIG. 2B;

FIG. 6A shows a top housing of a conventional stackable musical instrument case;

FIG. 6B shows a bottom housing of the conventional stackable musical instrument case;

FIG. 6C shows a side view of the conventional stackable musical instrument case; and

FIG. 6D shows a front view of multiple conventional stackable musical instrument cases that stack up.

### DETAILED DESCRIPTION OF THE INVENTION

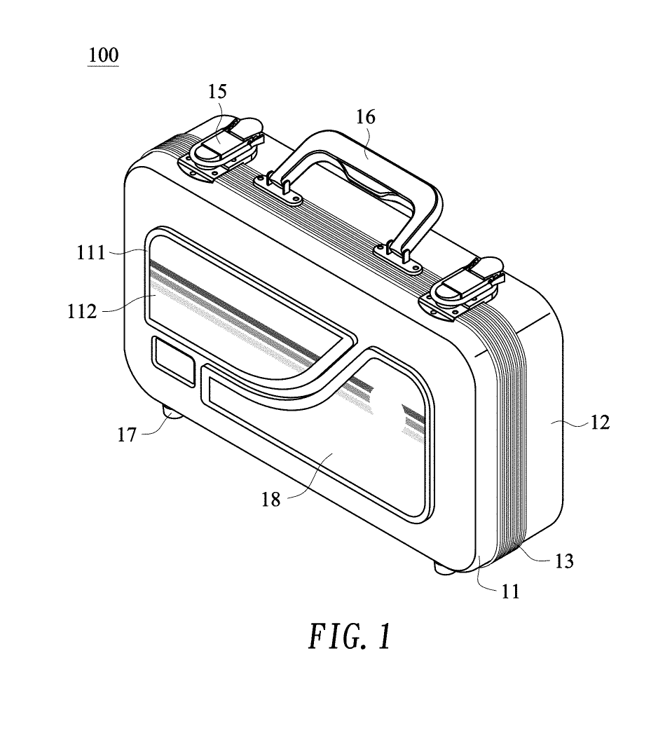

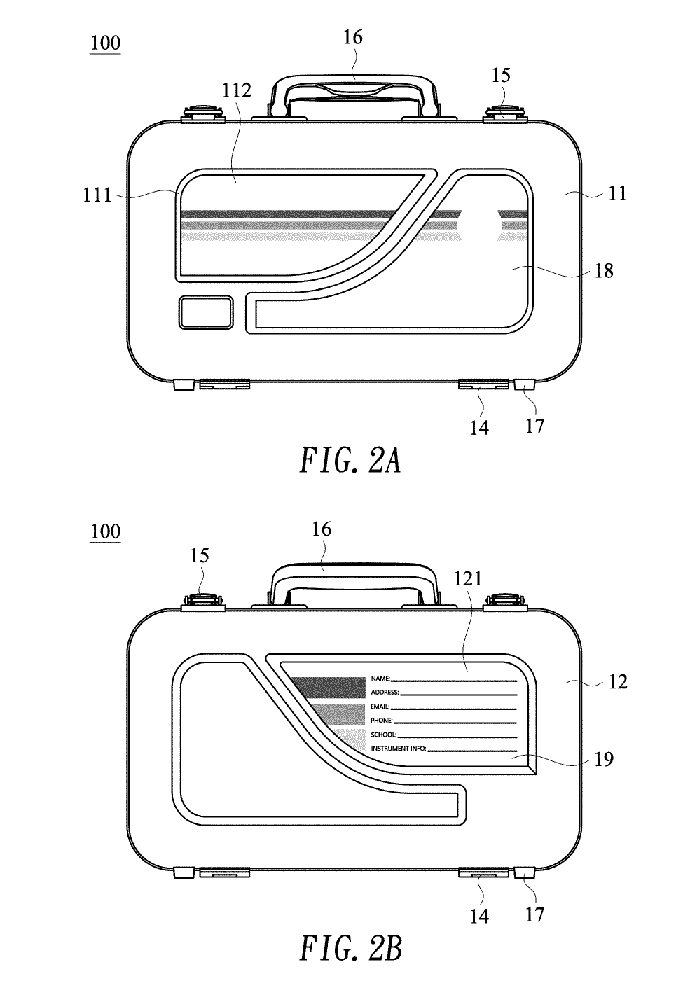

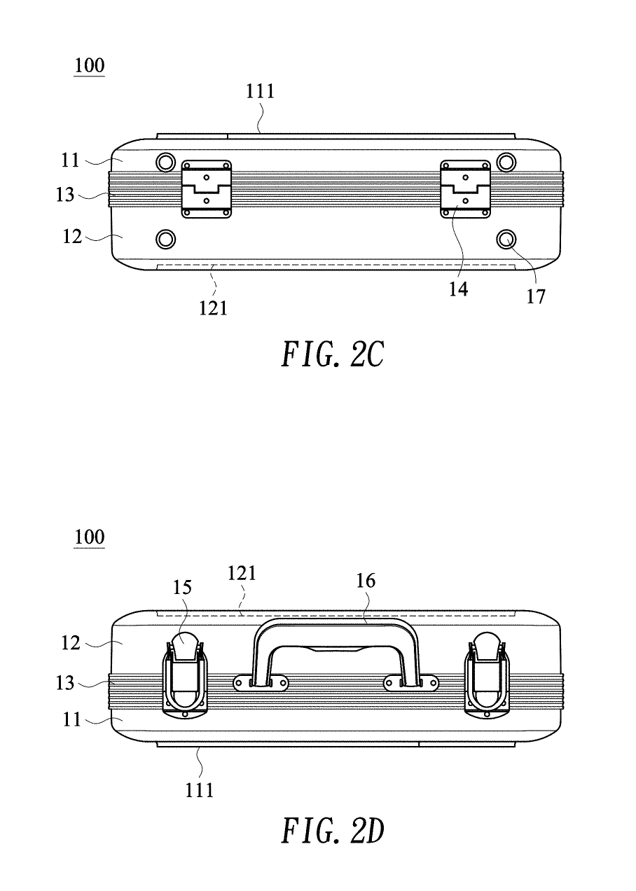

FIG. 1 shows a front perspective view illustrated of a musical instrument case 100 according to one embodiment of the present invention. FIG. 2A shows a front elevational view of the musical instrument case 100 of FIG. 1, FIG. 2B shows a rear elevational view of the musical instrument case 100 of FIG. 1, FIG. 2C shows a bottom plan view of the musical instrument case 100 of FIG. 1, and FIG. 2D shows a top plan view of the musical instrument case 100 of FIG. 1. The musical instrument case 100 of the embodiment may primarily, but not exclusively, be utilized to carry a portable musical instrument. The musical instrument case 100 of the embodiment may carry a variety of musical instruments such as stringed instruments, wind instruments, and percussion instruments. The shape of the musical instrument case 100 of the embodiment is merely served as an example, which may be modified according to the shape of a musical instrument to be carried.

In the embodiment, the musical instrument case 100 may include a first housing 11 and a second housing 12. In one example, the first housing 11 is a front housing and the second housing 12 is a rear housing. An interior of the first housing 11 and an interior of the second housing 12 are hollow, and face each other to collectively provide a space for accommodating a musical instrument. The first housing 11 and the second housing 12 may be made of synthetic resin. In one preferred embodiment, the first housing 11 and the second housing 12 may be made of Acrylonitrile Butadiene Styrene (ABS), which is a thermoplastic polymer with high hardness, toughness and moldability.

The musical instrument case 100 of the embodiment may include a plurality of frames 13, which are disposed on peripheries of the first housing 11 and the second housing 12, respectively. The frames 13 may be made of metal or other suitable materials. In a preferred embodiment, the frame 13 may be made of Aluminum alloy.

The musical instrument case 100 of the embodiment may include at least one hinge 14, which is disposed on a bottom surface of the first housing 11 and a corresponding bottom surface of the second housing 12, for joining the first housing 11 and the second housing 12 so that they can swing freely in order to facilitate opening or closing the musical instrument case 100. As exemplified in, but not limited to, FIG. 2C, the musical instrument case 100 of the embodiment may include two hinges 14. The musical instrument case 100 may include at least one lock 15, which is disposed on a top surface of the first housing 11 and a corresponding top surface of the second housing 12, for fastening the first housing 11 and the second housing 12 in order to prevent unexpected opening. As exemplified in, but not limited to, FIG. 2D, the musical instrument case 100 of the embodiment may include two locks 15.

The musical instrument case 100 of the embodiment may include a handle 16, which is disposed on the first housing 11 or the second housing 12. As exemplified in, but not limited to, FIG. 2D, the handle 16 of the embodiment is disposed on a top surface of the second housing 12. The handle 16 may be made of plastic or other suitable materials. The musical instrument case 100 of the embodiment may include a plurality of legs 17, which are disposed on bottom surfaces of the first housing 11 and the second housing 12 so that the musical instrument case 100 can firmly rest on a floor. In the embodiment, the legs 17 are fixed elements protruding from the bottom surfaces of the first housing 11 and the second housing 12. The leg 17 may be made of plastic or other suitable materials. In another embodiment, the leg 17 may be replaced with a swivel wheel for moving the musical instrument case 100 in a labor-saving manner.

According to one aspect of the embodiment, a linear ridge 111 is disposed on, and protruding from, an outer surface of the first housing 11 to define a predetermined area 112. As exemplified in FIG. 2A, the musical instrument case 100 of the embodiment may include two ridges 111, which define two predetermined areas 112, respectively. Each predetermined area 112 associated with a corresponding ridge 111 may be closed type or open type. The shape and amount of the predetermined areas 112 as shown in the figures are merely served as an example, which may be modified according to specific requirements. In one preferred, but not limited, embodiment, a total measured area of the predetermined areas 112 enclosed by the ridges 111 to a total measured area of the first housing 11 ratio has a range between 30% and 80%. The ridge 111 and the first housing 11 of the embodiment may be integrally formed. Alternatively, the ridge 111 and the first housing 11 may be individually made and then fixed together, for example, by glue. In one preferred, but not limited, embodiment, the ridge 111 has a width ranging between 5 millimeters (mm) and 25 mm, and has a thickness ranging between 5 mm and 25 mm.

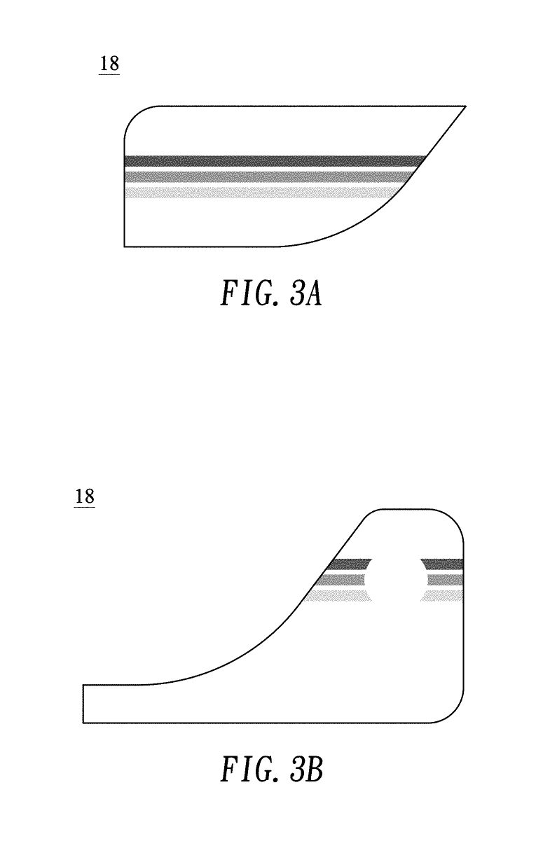

According to another aspect of the embodiment, the musical instrument case 100 may include at least one decal or sticker 18 for sticking unto the predetermined area 112 enclosed by the ridge 111. FIG. 3A and FIG. 3B show two exemplary decals 18 for sticking unto the predetermined areas 112 of FIG. 2A respectively. As the decals 18 are stuck onto the predetermined areas 112 enclosed by the ridges 111, the decals 18 can be protected by the ridges 111 from scratching, warping and detaching.

The decal 18 of the embodiment facilitates visual appeal, ownership identification, branding, added value, and customization. In one preferred embodiment, the decal 18 may be made of Polypropylene (PP) synthetic paper, where PP is semi-crystallized thermoplastic with high impact resistance, mechanical properties, resistance to organic solvent and corrosion. A pressure-sensitive adhesive (PSA) is applied to a bottom of the decal 18 to facilitate easy removal, reusability, and leaving no residue on a surface of the first housing 11.

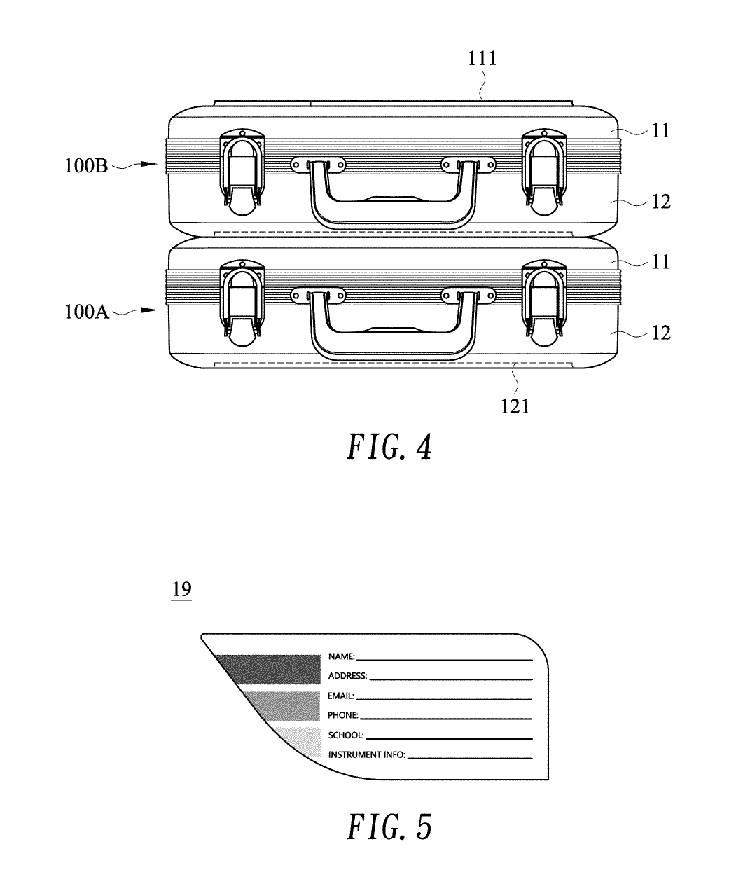

According to a further aspect of the embodiment, the second housing 12 has at least one recess 121 on an outer surface thereof. A contour of the recess 121 approximately corresponds to (i.e., is the same as or slightly larger than) an outer periphery of the ridge 111 of the first housing 11, and a depth of the recess 121 is substantially the same as or larger than the thickness of the ridge 111. Accordingly, when two musical instrument cases 111 are stacked with the second housing 12 of the top musical instrument case 111 facing the first housing 11 of the bottom musical instrument case 111, the ridge 111 (of the first housing) embeds itself in the recess 121 (of the second housing). FIG. 4 show a front view of a second musical instrument case 100B being stacked on top of a first musical instrument case 100A that is horizontally placed. As shown in the figure, the ridges 111 of the (bottom) first musical instrument case 100A embed in the recesses 121 of the (top) second musical instrument case 100B. As a result, multiple musical instrument cases 100A and 100B may be firmly stacked to save storage space. A decal or sticker 19 may be stuck onto the recess 121 of the second housing 12. FIG. 5 shows one exemplary decal 19 for sticking unto the recess 121 of FIG. 2B. The purposes, advantages and materials of the decal 19 of the second housing 12 are similar to the decal 18 of the first housing 11, and details are thus omitted for brevity.

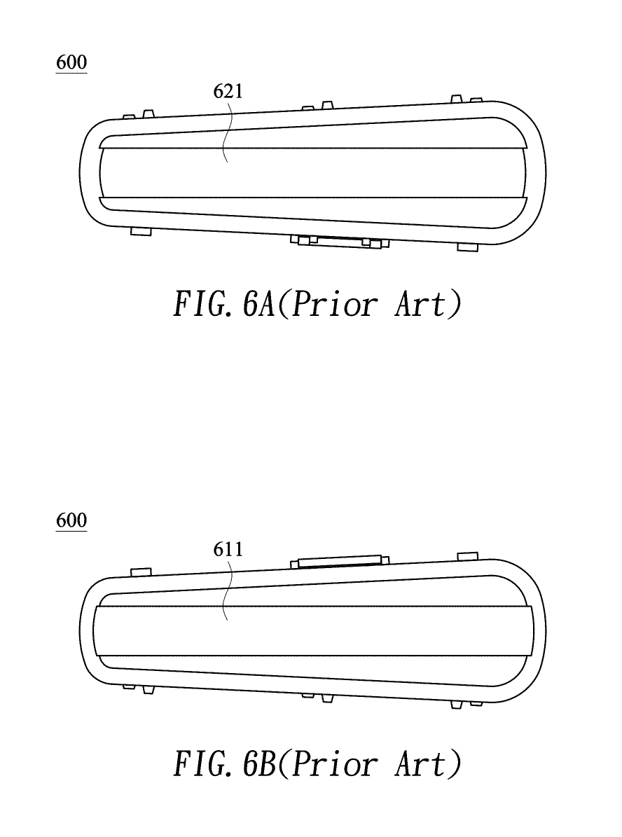

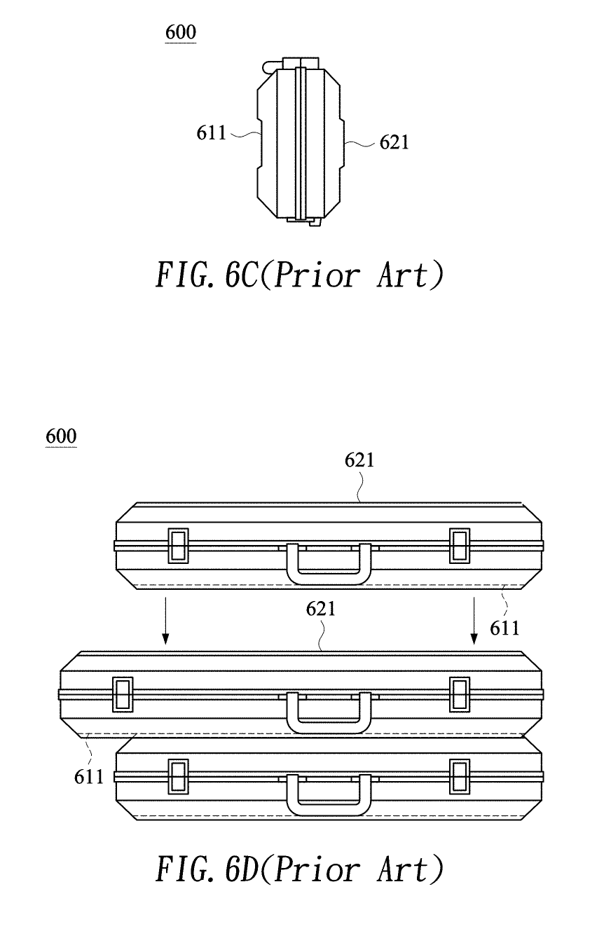

FIG. 6A shows a top housing of a conventional stackable musical instrument case 600 disclosed in US Patent Publication No. 2004/0007438, FIG. 6B shows a bottom housing of the conventional stackable musical instrument case 600, FIG. 6C shows a side view of the conventional stackable musical instrument case 600, and FIG. 6D shows a front view of multiple conventional stackable musical instrument cases 600 that stack up. Compared to the conventional stackable musical instrument case 600, the musical instrument case 100 of the embodiment has at least the following advantages.

The top housing of the conventional stackable musical instrument case 600 has a projection 621 (FIG. 6A) that is protruded to an entire extent. Moreover, the bottom housing of the conventional stackable musical instrument case 600 has a hollow 611 (FIG. 6B). Assume a sticker is stuck onto the projection 621 (FIG. 6A) of (the top housing of) the conventional stackable musical instrument case 600, and/or a sticker is stuck onto the hollow 611 (FIG. 6B) of the bottom housing. When multiple musical instrument cases 600 stack up, the projection 621 (of the top housing) embeds in the hollow 611 (of the bottom housing). As the entire surface of the projection 621 physically contacts with the hollow 611, the sticker on the projection 621 and/or the sticker on the hollow 611 are subject to scratching, warping and detaching.

To the contrary, with respect to the first housing 11 of the musical instrument case 100 of the embodiment, only the linear ridge 111 protrudes. The predetermined area 112 enclosed by the ridge 111 does not protrude, but is disposed at the same level as other surface of the first housing 11. When multiple musical instrument cases 100 stack up, the ridge 111 (of the first housing) embeds in the recess 121 (of the second housing). As only the ridge 111 physically contacts with the recess 121, the decal on the predetermined area 112 and/or the decal on the recess 121 is not affected by the other side.

According to the embodiment disclosed above, the ridge 11 of the first housing 11 and the recess 121 of the second housing 12 not only provide a stacking mechanism, but also furnish a protective space for sticking decals, thereby facilitating visual appeal, ownership identification, branding, added value, customization, and, more importantly, protecting the decals from scratching, warping and detaching.

Although specific embodiments have been illustrated and described, it will be appreciated by those skilled in the art that various modifications may be made without departing from the scope of the present invention, which is intended to be limited solely by the appended claims.

1. A musical instrument case, comprising:
a first housing and a second housing that are hollow to collectively provide a space for accommodating a musical instrument;
a ridge disposed on the first housing to define a predetermined area;
wherein the second housing has at least one recess with a contour corresponding to a periphery of the ridge, according to which the ridge of the first housing embeds in the recess of the second housing when two musical instrument cases are stacked; and
wherein the ridge is raised to a level higher than the predetermined area enclosed by the ridge and an area outside the ridge such that, when two musical instrument cases are stacked, the ridge of the first housing contacts the recess of the second housing but the predetermined area enclosed by the ridge of the first housing does not contact the recess of the second housing.

2. The musical instrument case of claim 1, wherein the first housing and the second housing comprise synthetic resin.

3. The musical instrument case of claim 2, wherein the synthetic resin comprises Acrylonitrile Butadiene Styrene.

4. The musical instrument case of claim 1, further comprising a plurality of frames, which are disposed on peripheries of the first housing and the second housing, respectively.

5. The musical instrument case of claim 4, wherein the plurality of frames comprise Aluminum alloy.

6. The musical instrument case of claim 1, further comprising at least one decal for sticking unto the predetermined area or the recess.

7. The musical instrument case of claim 6, wherein the at least one decal comprises Polypropylene synthetic paper, and a pressure-sensitive adhesive applied to a bottom of the Polypropylene synthetic paper.

8. The musical instrument case of claim 1, further comprising at least one hinge disposed on a bottom surface of the first housing and a corresponding bottom surface of the second housing.

9. The musical instrument case of claim 1, further comprising at least one lock disposed on a top surface of the first housing and a corresponding top surface of the second housing.

10. The musical instrument case of claim 1, further comprising a handle disposed on the first housing or the second housing.

11. The musical instrument case of claim 1, further comprising a plurality of legs disposed on bottom surfaces of the first housing and the second housing.

12-21. (canceled)
